(19) United States
(12) Patent Application Publication
(10) Pub. No.: US 2009/0245594 A1
(43) Pub. Date: Oct. 1, 2009

(54) IRIS IMAGING AND IRIS-BASED IDENTIFICATION

(75) Inventors: Gil Abramovich, Niskayuna, NY (US); Ambalangoda Gurunnanselage Amitha Perera, Clifton Park, NY (US); Robert William Tait, Niskayuna, NY (US); Frederick Wilson Wheeler, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 12/058,969

(22) Filed: Mar. 31, 2008

(51) Int. Cl. G06K 9/00

(52) U.S. Cl. 382/117

(57) ABSTRACT

An iris of an individual is imaged while illuminated with electromagnetic radiation having an illumination spectrum that is selected based on a color of the iris. The illumination spectrum/spectra is/are selected so that the resulting image will have a sufficient amount of detail of the iris as required for the application, such as identification of the individual. Alternatively, the iris can be imaged multiple times while illuminated by electromagnetic radiation of one of multiple different illumination spectra, and the best image or a combination of the images can be used for the application.

### TECHNICAL FIELD

The disclosure relates generally to biometric identification, and more particularly to identifying an individual based on attributes of his/her iris.

### BACKGROUND ART

The iris is a desirable biometric identifier for providing building and room access control, and for other security applications. The patterns of the iris are unique, and it is straightforward to quickly and accurately identify an individual based on his/her iris pattern.

It has been recognized that typically, dark eyes are harder to image with detailed texture using visible light. However, visible light may be sufficient for light-colored eyes. With a visible light imaging system, dark irises are captured at low contrast. As a result, an eye match score that is generated to identify an individual is insufficient for these irises. To this extent, iris-matching performance may be enhanced for dark-eyed individuals through the use of near infrared (NIR) illumination. While the longer wavelengths of electromagnetic radiation (above approximately 800 nanometers) provide better contrast for dark colors, they are not necessarily optimal for light-colored eyes. For current identification systems, a light wavelength is selected that is a tradeoff for all possible eye shades.

### SUMMARY

An iris of an individual is imaged while illuminated with electromagnetic radiation having an illumination spectrum that is selected based on a color of the iris. The illumination spectrum/spectra is/are selected so that the resulting image will have a sufficient amount of detail of the iris as required for the application, such as identification of the individual. Alternatively, the iris can be imaged multiple times while illuminated by electromagnetic radiation of one of multiple different illumination spectra, and the best image or a combination of the images can be used for the application.

A first aspect of the disclosure provides a method of identifying an individual, the method comprising: acquiring at least one attribute of the individual; selecting one of a plurality of possible illumination spectra based on the at least one attribute; illuminating an eye of the individual with electromagnetic radiation having the illumination spectrum; capturing an image of the eye while the eye is illuminated with the electromagnetic radiation having the illumination spectrum; and identifying the individual based on the image.

A second aspect of the disclosure provides a method of identifying an individual, the method comprising: illuminating an eye of the individual with electromagnetic radiation having a first illumination spectrum; capturing a first image of the eye while the eye is illuminated with the electromagnetic radiation having the first illumination spectrum; repeating the illuminating and capturing for at least one different illumination spectrum; and identifying the individual based on the captured images.

A third aspect of the disclosure provides a system for identifying an individual, the system comprising: a set of illumination devices, the set of illumination devices being configurable to emit electromagnetic radiation having at least one of a plurality of possible illumination spectra; an imaging device that captures an image of an eye of the individual; and a computer system for selecting at least one of the plurality of possible illumination spectra, operating the set of illumination devices to emit the selected at least one of the plurality of possible illumination spectra, operating the imaging device to capture the image while the eye is illuminated, and identifying the individual based on the captured image.

A fourth aspect of the disclosure provides a method of identifying an individual, the method comprising: illuminating an eye of the individual with electromagnetic radiation having a plurality of selected illumination spectra, wherein each selected illumination spectrum yields a detailed image for an iris of a particular color; capturing an image of the eye while it is illuminated with the electromagnetic radiation having the plurality of illumination spectra; processing the image to generate a plurality of separate images, each separate image corresponding to one of the plurality of selected illumination spectra; and identifying the individual based on the plurality of separate images.

A fifth aspect of the disclosure provides a method comprising: capturing a first image of an iris under visible light; measuring a color of the iris from the first image; selecting one of a plurality of possible illumination spectra based on the color; illuminating the iris with electromagnetic radiation having the selected illumination spectrum; and capturing a second image of the iris while the iris is illuminated with the electromagnetic radiation having the selected illumination spectrum.

A sixth aspect of the disclosure provides a system comprising: a set of illumination devices, the set of illumination devices being configurable to emit electromagnetic radiation having one of a plurality of possible illumination spectra; an imaging device that captures an image of an iris; and a computer system for operating the set of illumination devices and imaging device to: capture a first image of the iris under visible light; measure a color of the iris from the first image; select an illumination spectrum based on the color; illuminate the iris with electromagnetic radiation having the illumination spectrum; and capture a second image of the iris while it is illuminated with the electromagnetic radiation having the illumination spectrum.

A seventh aspect of the disclosure provides a computer program comprising program code embodied in at least one computer-readable medium, which when executed, enables a computer system to implement a method of imaging an iris and/or identifying an individual as described herein.

An eighth aspect of the disclosure provides a method of generating a system for imaging an iris and/or identifying an individual, the method comprising: providing a computer system operable to implement a method described herein.

A ninth aspect of the disclosure provides a method comprising: at least one of providing or receiving a copy of a computer program that is embodied in a set of data signals, wherein the computer program enables a computer system to implement a method of imaging an iris and/or identifying an individual as described herein.

Other aspects of the disclosure provide methods, systems, program products, and methods of using and generating each, which include and/or implement some or all of the features described herein. The illustrative aspects of the disclosure are designed to solve one or more of the problems herein described and/or one or more other problems not discussed.

### BRIEF DESCRIPTION OF THE DRAWINGS

These and other features of the disclosure will be more readily understood from the following detailed description of the various aspects of the disclosure taken in conjunction with the accompanying drawings that depict various aspects of the disclosure.

FIG. 1 shows an illustrative system for identifying an individual according to an embodiment of the invention.

FIG. 2 shows an illustrative process for identifying an individual according to an embodiment of the invention.

FIG. 3 shows another illustrative process for identifying an individual according to an embodiment of the invention.

It is noted that the drawings are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As indicated above, an iris of an individual is imaged while illuminated with electromagnetic radiation having an illumination spectrum that is selected based on a color of the iris. The illumination spectrum/spectra is/are selected so that the resulting image will have a sufficient amount of detail of the iris as required for the application, such as identification of the individual. Alternatively, the iris can be imaged multiple times while illuminated by electromagnetic radiation of one of multiple different illumination spectra, and the best image or a combination of the images can be used for the application. As used herein, unless otherwise noted, the term “set” means one or more (i.e., at least one) and the phrase “any solution” means any now known or later developed solution.

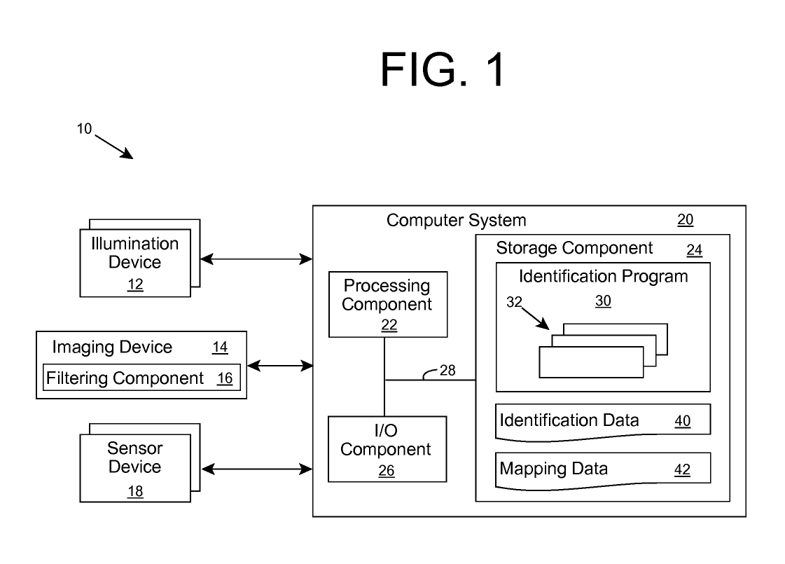

Turning to the drawings, FIG. 1 shows an illustrative system 10 for identifying an individual according to an embodiment. To this extent, system 10 includes a computer system 20 that can perform a process described herein to identify an individual. In particular, computer system 20 is shown including an identification program 30, which makes computer system 20 operable to acquire information about the individual and to identify the individual using the information by performing a process described herein. To this extent, while performing the process, computer system 20 can operate one or more devices 12, 14, 18, or components thereof, in order to acquire the information using any solution.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as identification program 30, which is at least partially embodied in storage component 24. While executing program code, processing component 22 can process data, which can result in reading and/or writing the data to/from storage component 24 and/or I/O component 26 for further processing. Pathway 28 provides a communications link between each of the components in computer system 20. I/O component 26 can comprise one or more human I/O devices, which enable a human user to interact with computer system 20 and/or one or more communications devices to enable another system or a device to communicate with computer system 20 using any type of communications link. To this extent, identification program 30 can manage a set of interfaces (e.g., graphical user interface(s), application program interface, and/or the like) that enable human and/or system users to interact with identification program 30. Further, identification program 30 can manage (e.g., store, retrieve, create, manipulate, organize, present, etc.) the data, such as identification data 40 and mapping data 42, using any solution.

In any event, computer system 20 can comprise one or more general purpose computing articles of manufacture (e.g., computing devices) capable of executing program code installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, identification program 30 can be embodied as any combination of system software and/or application software.

Further, identification program 30 can be implemented using a set of modules 32. In this case, a module 32 can enable computer system 20 to perform a set of tasks used by identification program 30, and can be separately developed and/or implemented apart from other portions of identification program 30. As used herein, the term “component” means any configuration of hardware, with or without software, which implements and/or enables a computer system 20 to implement the functionality described in conjunction therewith using any solution, while the term “module” means program code that enables a computer system 20 to implement the functionality described in conjunction therewith using any solution. When embodied in a tangible medium of expression, a module is a component. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of identification program 30 embodied thereon (e.g., one or more modules 32). However, it is understood that computer system 20 and identification program 30 are only representative of various possible equivalent computer systems that may perform a process described herein. To this extent, in other embodiments, the functionality provided by computer system 20 and identification program 30 can be at least partially implemented by one or more computing devices that include any combination of general and/or specific purpose hardware with or without program code. In each embodiment, the hardware and program code, if included, can be created using standard engineering and programming techniques, respectively.

When computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, identification program 30 enables computer system 20 to identify an individual using one or more images of an eye of the individual. The inventors propose that a dependency exists between eye color and an optimum illumination spectrum of electromagnetic radiation illuminating the eye while imaging the eye. In particular, the inventors propose that for different eye colors, illumination of the eye with electromagnetic radiation having different predominant illumination spectra will yield images having more detail of the iris. By selecting an illumination spectrum that provides the most detail for the eye color, system 10 can provide images of the iris that have sufficient iris texture for the application, e.g., to perform an identification. To this extent, system 10 can acquire an image of the eye of the individual under one of a plurality of selectable illumination spectra.

System 10 includes a set of illumination devices 12. Illumination device(s) 12 can be configured to emit electromagnetic radiation having one of a plurality of possible illumination spectra. As used herein, an “illumination spectrum” means a set of predominant wavelengths of electromagnetic radiation that is emitted by illumination device(s) 12. The set of predominant wavelengths can include one or more wavelengths, and can be a highly specific, spectrally narrow band (e.g., having a spectral power distribution with one or more relatively close dominant wavelengths) or a more general, spectrally broad band (e.g., having a spectral power distribution with a range of wavelengths having relatively even power). To this extent, illumination device(s) 12 can include one or more light emitting devices, such as light emitting diodes (LEDs) (infrared, visible, or ultraviolet), a broad spectrum radiation source with filter(s), and/or the like, which emit electromagnetic radiation having varying dominant wavelengths. The dominant wavelength(s) of each illumination device 12 can be in the visible spectrum (e.g., between approximately 380 and 750 nanometers) and/or the near infrared region of the electromagnetic spectrum (e.g., between approximately 750 and 1600 nanometers). Further, illumination device(s) 12 can include one or more sources of white light (e.g., LED, incandescent lamp, and/or the like).

Computer system 20 can operate the set of illumination devices 12 so that a subset and/or all of the illumination device(s) 12 are utilized to emit electromagnetic radiation having a desired illumination spectrum using any solution. Further, computer system 20 can operate illumination device(s) 12 so that the emitted electromagnetic radiation has a desired intensity using any solution. To this extent, computer system 20 can select one of the possible illumination spectra and a corresponding intensity for the electromagnetic radiation, and operate the set of illumination devices 12 to emit electromagnetic radiation having the selected illumination spectrum and corresponding intensity. Computer system 20 can operate the set of illumination devices 12 by, for example, turning one or more of the illumination devices 12 on or off, varying a power supplied to one or more of the illumination devices 12, and/or the like.

Additionally, computer system 20 can operate imaging device 14 to capture an image of an eye of an individual. For example, computer system 20 can instruct imaging device 14 to capture the image while the eye is illuminated by illumination device(s) 12 with electromagnetic radiation having a selected illumination spectrum. Computer system 20 can automatically adjust a duration of an exposure for acquiring the image, an intensity of the electromagnetic radiation emitted by illumination device(s) 12, and/or the like, to, for example, reduce an influence of ambient light on an image, reduce an amount of motion blur, and/or the like. Imaging device 14 can provide the captured image to computer system 20, which can store the image as identification data 40 using any solution (e.g., as a JPEG file). Imaging device 14 and/or computer system 20 can include additional data with the image, such as a date/time stamp, other identification data for the individual, the selected illumination spectrum, a location, and/or the like.

Imaging device 14 can include a filtering component 16, which can filter various wavelengths of electromagnetic radiation. Filtering component 16 can be utilized to prevent, for example, electromagnetic radiation having wavelengths outside of the selected illumination spectrum (e.g., ambient light) from passing through and being imaged by imaging device 14. Filtering component 16 can comprise a single filter that allows electromagnetic radiation of all the selectable wavelengths to pass through, a tunable or selectable wavelength filter, and/or the like. In the latter case, computer system 20 can operate filtering component 16 using any solution. For example, computer system 20 can instruct filtering component 16 to filter all electromagnetic radiation outside of a selected illumination spectra. While shown as part of imaging device 14, it is understood that some or all of filtering component 16 could be implemented apart from imaging device 16. Imaging device 14 can comprise any type of sensor capable of imaging the desired illumination spectra, such as an image sensor, a camera, a thermographic camera, and/or the like. Similarly, filtering component 16 can comprise any type of filter capable of blocking undesired wavelengths of electromagnetic radiation, such as an optical and/or infrared filter, an electronic filter, and/or the like.

System 10 also can include one or more additional sensor devices 18, which can be operated by computer system 20. For example, one or more sensor devices 18 can acquire non-image data for the individual. To this extent, computer system 20 can utilize sensor device(s) 18 to implement any automatic identification and data capture (AIDC) solution. Examples of such solutions include: acquiring information from an identification badge, such as reading a bar code, acquiring a radio frequency identification (RFID), acquiring data from a magnetic stripe, and/or the like; acquiring biometric data, such as a fingerprint, voice recognition, and/or the like; etc. Computer system 20 can receive such data from sensor device(s) 18 and store the data as identification data 40 for the individual.

Similarly, computer system 20 can use one or more sensor devices 18 to adjust the operation of illumination device(s) 12 and/or imaging device 14. For example, computer system 20 can use feedback data received from a set of sensor devices 18, such as photodetector(s), to adjust the operation of illumination device(s) 12 using any solution (e.g., to acquire a desired illumination spectrum and/or intensity). Additionally, computer system 20 can use environmental data received from a set of sensor devices 18, such as imaging device(s), to adjust the operation of illumination device(s) 12 and/or imaging device 14 using any solution (e.g., to adjust a zoom, direction of operation, and/or the like).

System 10 can implement one or more of various processes for identifying an individual based on features of an eye (e.g., an iris) of the individual. To this extent, computer system 20 can manage (e.g., store, access, modify, etc.) identification data 40, which computer system 20 can use in later identifying an individual, using any solution. Identification data 40 can include one or more images of the eye of an individual and/or data extracted from the one or more images. Additionally, identification data 40 can include other information, such as information on a badge assigned to the individual, other biometric information (e.g., fingerprint, voice print, and/or the like) of the individual, and/or the like.

Similarly, computer system 20 can manage mapping data 42, which maps one or more attributes to a particular illumination spectrum. For example, computer system 20 can obtain a set of pre-specified mappings, each of which maps identification data 40 for an individual to a corresponding illumination spectrum, using any solution. In this case, mapping data 42 can map badge information, biometric information, and/or the like, to a corresponding illumination spectrum. Similarly, mapping data 42 can map an attribute of an eye to a particular illumination spectrum, which is not individualized. For example, an eye color can be mapped to an illumination spectrum, which provides the most detail of the iris when the eye is imaged under the illumination spectrum.

Computer system 20 can obtain identification data 40 and/or mapping data 42 using any solution. For example, computer system 20 can operate illumination device(s) 12, imaging device 14, and/or sensor device(s) 18 to acquire identification data 40, receive identification data 40 and/or mapping data 42 from another system, and/or the like. Similarly, as part of an initialization process or the like, computer system 20 can acquire and analyze multiple images of an iris of the individual and/or different colored irises of multiple individuals that results when the iris(es) is (are) illuminated by electromagnetic radiation of multiple different illumination spectra. Computer system 20 or a user thereof can determine from the images the illumination spectrum that provides the most detail of the iris, and map the individual and/or iris color to the illumination spectrum. Computer system 20 can extract additional identification data 40 (e.g., eye color, identifying patterns in the iris/fingerprint/voice, etc.) and/or mapping data 42 from identification data 40, receive extracted identification data 40 and/or mapping data 42 from another system, and/or the like. Regardless, computer system 20 can store identification data 40 and/or mapping data 42 for use in identifying an individual at a later time.

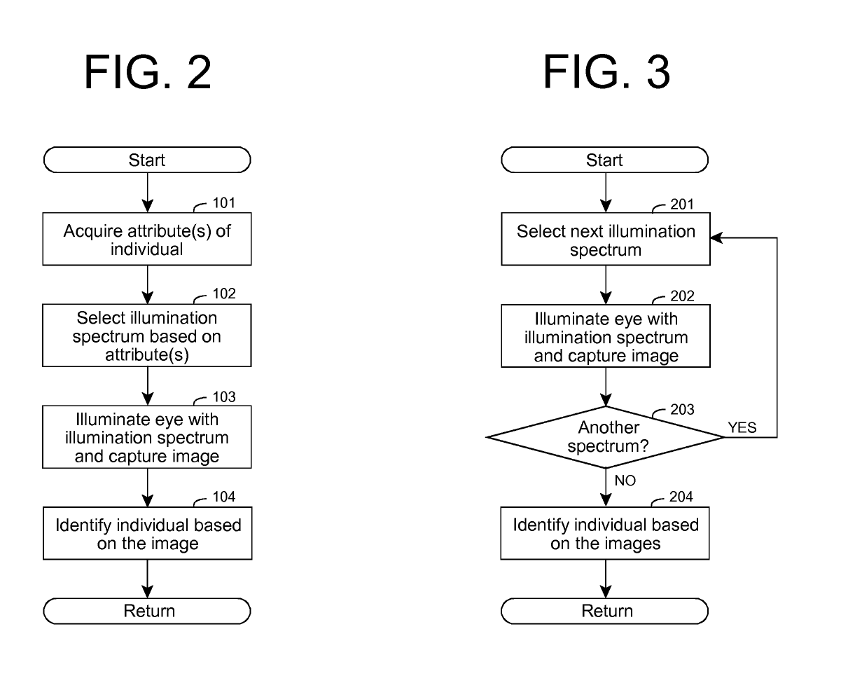

FIG. 2 shows an illustrative process for identifying an individual according to an embodiment, which can be implemented by system 10 (FIG. 1). Referring to FIGS. 1 and 2, in process 101, computer system 20 can acquire a set of attributes of an individual. In an embodiment, the attribute(s) include identification data 40. To this extent, computer system 20 can obtain identification data 40 from sensor device(s) 18, which computer system 20 can use to determine a preliminary identification of the individual. For example, a sensor device 18 can acquire identification data 40 from an identification badge associated with the individual, biometric information of the individual, and/or the like. Using this information, computer system 20 can determine a preliminary identification of the individual using the newly acquired and stored identification data 40.

In an embodiment, the set of attributes includes an eye color of the individual. To this extent, computer system 20 can capture an image of an eye of the individual under visible light (e.g., electromagnetic radiation having wavelengths in the visible spectrum). For example, computer system 20 can operate illumination device(s) 12 to emit visible light (e.g., white light), which illuminates the eye, and operate imaging device 14 to acquire an image of the eye while it is illuminated with the visible light. Alternatively, computer system 20 can capture the image using ambient light. In any event, computer system 20 can measure a color of the iris of the eye from the visible light image using any solution.

In process 102, computer system 20 can select an illumination spectrum based on the set of attributes. For example, when the set of attributes includes identification data 40, computer system 20 can obtain a pre-specified mapping in mapping data 42 that maps the preliminary identification to a corresponding illumination spectrum. Similarly, when the set of attributes includes an eye color, computer system 20 can obtain a pre-specified mapping in mapping data 42 that maps the eye color to a corresponding illumination spectrum. In any event, in process 103, computer system 20 can operate illumination device(s) 12 to illuminate an eye of the individual with electromagnetic radiation having the corresponding illumination spectrum, and operate imaging device 14 to capture an image of the eye while it is illuminated with the electromagnetic radiation having the illumination spectrum.

In process 104, computer system 20 can identify the individual based on the image captured under the selected illumination spectrum. For example, computer system 20 can extract various identifying patterns in the iris from the captured image and compare the extracted identifying patterns with identifying patterns stored in identification data 40. When computer system 20 locates a sufficiently close match between the respective identifying patterns, computer system 20 can identify the individual whose eye was imaged as the individual corresponding to the stored identifying patterns. Similarly, computer system 20 can perform image analysis on the captured image and previously captured images stored in identification data 40 to identify the individual. Depending on the application, it is understood that the identification can comprise an identification of a specific individual (e.g., to ensure the individual is allowed in a secured area), an identification of a generic individual (e.g., when tracking movement and/or a recurring presence of an unknown individual), or the like.

FIG. 3 shows another illustrative process for identifying an individual according to an embodiment, which can be implemented by system 10 (FIG. 1). Referring to FIGS. 1 and 3, system 10 can illuminate an eye of the individual with electromagnetic radiation having multiple different illumination spectra, and acquire an image of the eye under each illumination spectrum. To this extent, in process 201, computer system 20 can select a next illumination spectrum, and in process 202, computer system 20 can operate illumination device(s) 12 to illuminate an eye of the individual with electromagnetic radiation having the selected illumination spectrum, and operate imaging device 14 to capture an image of the eye while it is illuminated with the electromagnetic radiation having the selected illumination spectrum. In process 203, computer system 20 can determine whether the eye should be illuminated under another illumination spectrum, and if so, processing can return to process 201.

Otherwise, once computer system 20 has acquired an image for each of the illumination spectra, in process 204, computer system 20 can identify the individual based on the images. For example, in processes 201-203, system 10 can capture a first image of the eye while it is illuminated with visible light, computer system 20 can select a second illumination spectrum based on a color of the eye in the visible light image, and system 10 can capture a second image of the eye while it is illuminated with electromagnetic radiation having the selected illumination spectrum. Computer system 20 can identify the individual using the second image as discussed herein with respect to process 104.

In an embodiment, system 10 can capture images of the eye with different illumination spectra that yield detailed images of irises of different colors. In this case, computer system 20 can analyze the captured images, select an image that provided the most detail of the iris, and identify the individual using the selected image and identification data 40 as discussed herein with respect to process 104. In another embodiment, computer system 20 can construct an enhanced-contrast synthetic image using the plurality of images, e.g., by combining some or all of the plurality of images into a single image. Computer system 20 can use the enhanced-contrast synthetic image to identify the individual using the identification data 40 as discussed herein with respect to process 104. In another embodiment, computer system 20 separately identify the individual using each captured image and the identification data 40 as discussed herein with respect to process 104. Subsequently, computer system 20 can analyze the separate identifications to identify of the individual using any solution. For example, computer system can select an identification that is found most frequently, select an identification having the highest certainty, and/or the like.

In another embodiment, system 10 can simultaneously illuminate an eye with a plurality of different illumination spectra and/or a single broad spectrum of radiation, and capture an image of the eye while it is illuminated. For example, computer system 20 can select multiple illumination spectra and operate the set of illumination devices 12 to simultaneously emit electromagnetic radiation having the selected plurality of different illumination spectra. Each illumination spectrum can comprise, for example, an illumination spectrum that yields detailed images of an iris of a particular color. Alternatively, computer system 20 can operate the set of illumination devices 12 to emit radiation over a broad spectrum, which includes the various illumination spectra. Computer system 20 can operate imaging device 14 to capture an image of the eye while it is illuminated.

The resulting image can comprise an enhanced-contrast image, which computer system 20 can use to identify the individual using the identification data 40 as discussed herein with respect to process 104. Further, computer system 20 can process the image to generate a plurality of separate images, each corresponding to a different illumination spectrum. In this case, computer system 20 can separately identify the individual using each captured image and the identification data 40 as discussed herein with respect to process 104, and analyze the separate identifications to identify the individual.

The technical effects of embodiments of the invention described herein include the generation of image(s) of an iris that provide increased detail of the iris over previous approaches. It is understood that while the discussion herein expressly describes imaging a single eye, embodiments can include imaging both eyes of an individual. Additionally, while shown and described herein as a method and system for identifying an individual, it is understood that aspects of the disclosure further provide various alternative embodiments. For example, one or more of the imaging processes described herein can be implemented as part of one or more other types of applications that can use detailed images of an iris. In illustrative embodiments, an imaging process described herein can be implemented as part of a process for: performing medical evaluation/diagnosis; performing research; creating scientific literature; creating art; and/or the like.

Additionally, embodiments can comprise only the program code that enables system 10 (FIG. 1) to perform one or more of the processes described herein. For example, an embodiment provides a computer program embodied in at least one computer-readable medium, which when executed, enables a computer system to identify an individual. To this extent, the computer-readable medium includes program code, such as identification program 30 (FIG. 1), which implements some or all of a process described herein. It is understood that the term “computer-readable medium” comprises one or more of any type of tangible medium of expression capable of embodying a copy of the program code (e.g., a physical embodiment). For example, the computer-readable medium can comprise: one or more portable storage articles of manufacture; one or more memory/storage components of a computing device; paper; and/or the like. Further, a copy of the program code can be transitory, e.g., embodied in a modulated data signal having one or more of its characteristics set and/or changed in such a manner as to encode information in the signal.

In another embodiment, the disclosure provides a method of providing a copy of program code, such as identification program 30 (FIG. 1), which implements some or all of a process described herein. In this case, a computer system can generate and transmit, for reception at a second, distinct location, a set of data signals that has one or more of its characteristics set and/or changed in such a manner as to encode a copy of the program code in the set of data signals. Similarly, an embodiment provides a method of acquiring a copy of program code that implements some or all of a process described herein, which includes a computer system receiving the set of data signals described herein, and translating the set of data signals into a copy of the computer program embodied in at least one computer-readable medium. In either case, the set of data signals can be transmitted/received using any type of communications link.

In still another embodiment, the disclosure provides a method of generating a system for identifying an individual. In this case, a computer system, such as computer system 20 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device from a computer-readable medium; (2) adding one or more computing and/or I/O devices to the computer system; and (3) incorporating and/or modifying the computer system to enable it to perform a process described herein.

The foregoing description of various aspects of the disclosure has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of identifying an individual, the method comprising:
acquiring at least one attribute of the individual;
selecting one of a plurality of possible illumination spectra based on the at least one attribute;
illuminating an eye of the individual with electromagnetic radiation having the illumination spectrum;
capturing an image of the eye while the eye is illuminated with the electromagnetic radiation having the illumination spectrum; and
identifying the individual based on the image.

2. The method of claim 1, wherein the acquiring includes:
capturing a first image of the eye under visible light; and
measuring a color of an iris of the eye from the first image, wherein the at least one attribute comprises the color.

3. The method of claim 2, wherein the selecting includes obtaining a mapping of the color to the illumination spectrum from a plurality of pre-specified mappings.

4. The method of claim 1, wherein the acquiring includes obtaining a preliminary identification of the individual, and wherein the selecting includes obtaining a mapping of the preliminary identification to the illumination spectrum from a plurality of pre-specified mappings.

5. A method of identifying an individual, the method comprising:
illuminating an eye of the individual with electromagnetic radiation having a first illumination spectrum;
capturing a first image of the eye while the eye is illuminated with the electromagnetic radiation having the first illumination spectrum;
repeating the illuminating and capturing for at least one different illumination spectrum; and
identifying the individual based on the captured images.

6. The method of claim 5, the method further comprising selecting a second illumination spectrum based on the first image.

7. The method of claim 6, further comprising measuring a color of an iris of the eye from the first image, wherein the selecting includes obtaining a mapping of the color to the second illumination spectrum from a plurality of pre-specified mappings.

8. The method of claim 5, wherein the identifying includes:
constructing an enhanced-contrast synthetic image using the captured images; and
identifying the individual using the enhanced-contrast synthetic image.

9. The method of claim 5, wherein the identifying includes:
separately identifying the individual using each of the captured images; and
analyzing the separate identifications to identify the individual.

10. A system for identifying an individual, the system comprising:
a set of illumination devices, the set of illumination devices being configurable to emit electromagnetic radiation having at least one of a plurality of possible illumination spectra;
an imaging device that captures an image of an eye of the individual; and
a computer system for selecting at least one of the plurality of possible illumination spectra, operating the set of illumination devices to emit the selected at least one of the plurality of possible illumination spectra, operating the imaging device to capture the image while the eye is illuminated, and identifying the individual based on the captured image.

11. The system of claim 10, wherein the computer system further manages mapping data, wherein each mapping in the mapping data maps an attribute of the individual to an illumination spectrum, and wherein the selecting uses the mapping data.

12. The system of claim 11, wherein the attribute comprises a color of an iris of the individual.

13. The system of claim 12, wherein the computer system operates the set of illumination devices and the imaging device to:
capture a first image of the eye under visible light;
measure a color of an iris of the eye from the first image;
select an illumination spectrum from the mapping data based on the color of the iris;
illuminate the eye with electromagnetic radiation having the selected illumination spectrum; and
capture a second image of the eye while it is illuminated with the electromagnetic radiation having the illumination spectrum, wherein the identifying uses the second image.

14. The system of claim 11, wherein the computer system further manages identification data that includes data on a previously captured image of an eye for at least one individual, and wherein the attribute comprises identification data for the individual.

15. The system of claim 14, wherein the computer system operates the set of illumination devices and the imaging device to:
illuminate the eye of the individual with electromagnetic radiation having an illumination spectrum;
capture an image of the eye while it is illuminated with the electromagnetic radiation having the illumination spectrum; and
repeat the illuminating and capturing for a plurality of different illumination spectra, wherein the identifying uses each of the captured images and the identification data.

16. The system of claim 14, wherein the computer system operates the set of illumination devices and the imaging device to:
illuminate the eye of the individual with electromagnetic radiation having a plurality of selected illumination spectra, wherein each selected illumination spectrum yields a detailed image for an iris of a particular color; and
capture an image of the eye while it is illuminated with the electromagnetic radiation having the plurality of illumination spectra,
wherein the computer system further processes the image to generate a plurality of separate images, each separate image corresponding to one of the plurality of selected illumination spectra, and wherein the identifying uses the plurality of separate images and the identification data.

17. The system of claim 10, further comprising at least one sensor device that acquires non-image data of the individual, wherein the computer system uses the non-image data for selecting the illumination spectrum.

18. The system of claim 10, wherein at least some of the set of illumination devices emit electromagnetic radiation in the near infrared region of the electromagnetic spectrum.

19. A method comprising:
capturing a first image of an iris under visible light;
measuring a color of the iris from the first image;
selecting one of a plurality of possible illumination spectra based on the color;
illuminating the iris with electromagnetic radiation having the selected illumination spectrum; and
capturing a second image of the iris while the iris is illuminated with the electromagnetic radiation having the selected illumination spectrum.

20. The method of claim 19, further comprising identifying an individual based on the second image.

21. The method of claim 19, further comprising, for each of a plurality of different colored irises:
illuminating the iris with electromagnetic radiation having each of a plurality of different illumination spectra;
imaging the iris while the iris is illuminated with each of the plurality of different illumination spectra;
determining from the images the one of the plurality of different illumination spectra that provides the most detail of the iris; and
mapping the color of the iris to the determined one of the plurality of different illumination spectra.
